(19) United States
(12) Patent Application Publication
(10) Pub. No.: US 2008/0074263 A1
(43) Pub. Date: Mar. 27, 2008

(54) RFID system with peer-to-peer communication

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/527,077

(22) Filed: Sep. 26, 2006

(51) Int. Cl. G08B 13/14; H04Q 5/22

(52) U.S. Cl. 340/572.1; 340/10.1

(57) ABSTRACT

A radio frequency identification (RFID) system includes a network RFID reader, an RFID tag, and an RFID reader. The network RFID reader is coupled to a network connection. The RFID tag is coupled to generate an RFID response signal in response to an RFID signal. The RFID reader is coupled to provide the RFID signal to the RFID tag and to provide the RFID response signal to the network RFID reader.

### CROSS REFERENCE TO RELATED PATENTS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to wireless communication systems and more particularly to radio frequency identification (RFID) systems.

2. Description of Related Art

A radio frequency identification (RFID) system generally includes a reader, also known as an interrogator, and a remote tag, also known as a transponder. Each tag stores identification data for use in identifying a person, article, parcel or other object. RFID systems may use active tags that include an internal power source, such as a battery, and/or passive tags that do not contain an internal power source, but instead are remotely powered by the reader.

Communication between the reader and the remote tag is enabled by radio frequency (RF) signals. In general, to access the identification data stored on an RFID tag, the RFID reader generates a modulated RF interrogation signal designed to evoke a modulated RF response from a tag. The RF response from the tag includes the coded identification data stored in the RFID tag. The RFID reader decodes the coded identification data to identify the person, article, parcel or other object associated with the RFID tag. For passive tags, the RFID reader also generates an unmodulated, continuous wave (CW) signal to activate and power the tag during data transfer.

RFID systems typically employ either far-field technology, in which the distance between the reader and the tag is great compared to the wavelength of the carrier signal, or near-field technology, in which the operating distance is less than one wavelength of the carrier signal, to facilitate communication between the RFID reader and RFID tag. In far-field applications, the RFID reader generates and transmits an RF request signal via an antenna to all tags within range of the antenna. One or more of the tags that receive the RF signal responds to the reader using a backscattering technique in which the tags modulate and reflect the received RF signal. In near-field applications, the RFID reader and tag communicate via mutual inductance between corresponding reader and tag inductors.

Regardless of whether an RFID system uses far-field or near-field technology, the information concerning tags obtained by a reader needs to be forwarded to a computer and/or server for centralized processing. As such, each reader in the RFID system needs a connection to the computer and/or server. For example, each reader may include a hard wired connection to the computer and/or server. As another example, each reader may be affiliated with an access point of a wireless local area network. In either case, the required direct coupling of a reader to the computer and/or server adds substantial cost to the RFID system and/or limits the size of the RFID system.

Therefore, a need exists for a low cost RFID system that can be economically deployed in a substantial geographic area.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an RFID communication in accordance with the present invention;

FIG. 2 is a schematic block diagram of another RFID communication in accordance with the present invention;

FIG. 3 is a schematic block diagram of other RFID communications in accordance with the present invention;

FIG. 4 is a schematic block diagram of a reader in accordance with the present invention;

FIG. 5 is a logic diagram of a method for peer-to-peer communication in accordance with the present invention; and

FIG. 6 is a logic diagram of method for interpreting the inbound data in accordance with the present invention.

### DETAILED DESCRIPTION OF THE INVENTION

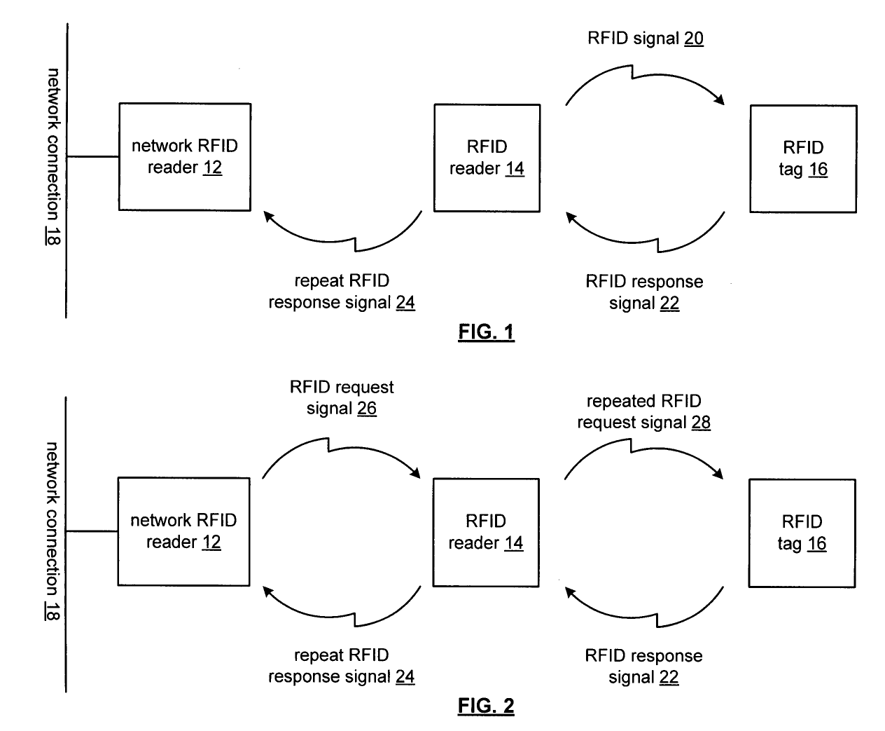

FIG. 1 is a schematic block diagram of a radio frequency identification (RFID) communication involving a network RFID reader 12, an RFID reader 14, and an RFID tag 16. The network RFID reader 12, which may include an RFID reader 14 and a network interfacing device (e.g., a wireless local area network transceiver, a cable modem, a satellite transceiver, an Ethernet transceiver, etc.), is coupled to a network connection 18 to provide data to and from a computer and/or server coupled to the network connection and RFID readers 14 and RFID tags 16 in the RFID system.

In this RFID communication, the RFID reader 14 provides an RFID signal 20 to the RFID tag 16. The RFID signal 20 may be a repeat of an RFID request message from the network RFID reader 12, a repeat of an RFID request message from another RFID reader in the RFID system, or an RFID request message generated by the RFID reader 14. Note that the RFID request message may be a command that directs an RFID tag to provide a response to a particular query, to store data, to delete data, to update data, and/or any other type of interactive messaging. Further note the RFID reader 14 may generate the RFID request message in response to a polling prompt from the network RFID reader 12, in response to a predetermined schedule, in response to detecting the presence of the tag, and/or as otherwise programmed.

The RFID tag 16 receives the RFID signal 20 and processes it to generate an RFID response signal 22. The RFID response signal 22 will be particular to the request message of the RFID signal 20. For example, the RFID response signal 22 may include an answer to a particular query, an acknowledgement that data has been stored, deleted, or updated, and/or an appropriate response to an interactive message.

The RFID reader 14 receives the RFID response signal 22 and generates therefrom a repeat RFID response signal 24. The RFID reader 14 provides the repeat RFID response signal 24 to the network RFID reader 12, which in turn provides the RFID response signal to the computer and/or server coupled to the network connection 18.

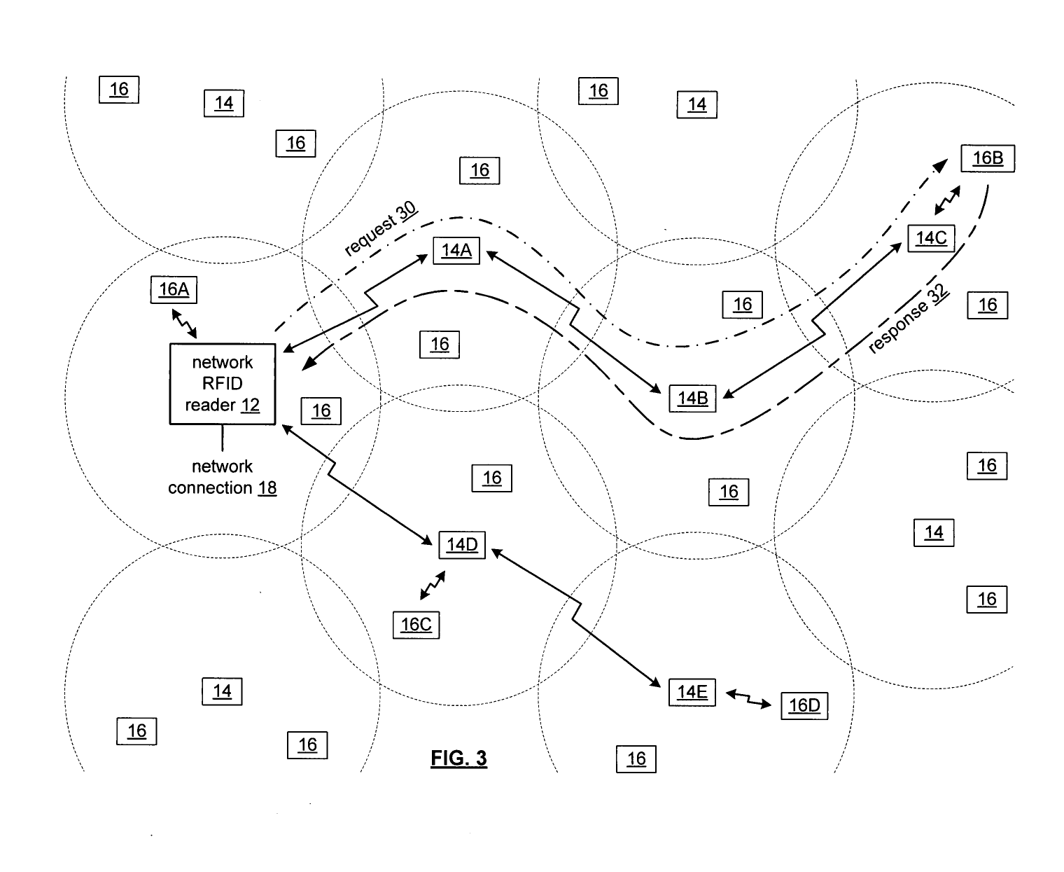

FIG. 2 is a schematic block diagram of another RFID communication involving a network RFID reader 12, an RFID reader 14, and an RFID tag 16. In this communication, the network RFID reader 12 generates an RFID request signal 26, which is repeated by the RFID reader 14. The RFID tag receives the repeated RFID request signal 28 and generates the RFID response signal 22 therefrom. The RFID reader 14 repeats the RFID response signal 22. The network RFID reader 12 receives the repeat RFID response signal 24 and provides the response to the computer and/or server coupled to the network connection 18.

In one embodiment, the RFID reader 14 receives the RFID request message, or signal 26, wherein the RFID request message has a first carrier frequency (e.g., 870-890 MHz) and repeats the RFID request message to the RFID tag using a second carrier frequency (e.g., 910-930 MHz). In this manner, blocking of the transmitted signal from the received signal within the RFID reader 14 is enhanced due to the frequency offset. In another embodiment, the RFID reader 14 repeats the RFID request message 28 using the same carrier frequency as the carrier frequency of the RFID request signal 26.

FIG. 3 is a schematic block diagram of four RFID communications involving the network RFID reader 12, a plurality of RFID readers 14, and a plurality of RFID tags 16. In this illustration, the network RFID reader 12 and the RFID readers 14 are physically distributed throughout a geographic area and the encircling dashed line represents the coverage area of the corresponding RFID reader 12 or 14. As such, if an RFID tag is located within the geographic area, which may be an office, an office complex, an airport, a cattle ranch, a forest preserve, a park, etc. it is in the coverage area of at least one RFID reader 14.

With respect to a first RFID communication, RFID tag 16A is located within the coverage area of the network RFID reader 12. As such, the network RFID reader 12 communicates directly (i.e., without relaying messages via one or more of the RFID readers) with the RFID tag 16A.

With respect to a second RFID communication, RFID tag 16B, is located in the coverage area of RFID reader 14C. As previously mentioned, an RFID request message may be generated by the RFID reader 14C or by the network RFID reader 12, which may be relaying the message from the computer and/or server coupled to the network connection. If the RFID reader 14C generated the RFID request message, it provides the message to the RFID reader 16B, which uses the RFID signal to generate a supply voltage to power the circuitry of the RFID reader 16. The circuitry processes the RFID request message to produce an RFID response message that is transmitted to the RFID reader 14C. Note that the transmission of the RFID response message may be done using backscattering on the same carrier frequency as the request message or on a different carrier frequency.

Upon receiving the RFID response message, the RFID reader 14C repeats it and forwards the repeat RFID response signal to RFID reader 14B. In one embodiment, the RFID reader 14C generates the repeat RFID response message as part of the response message 32 by first recovering data contained within the RFID response message to produce recovered data. The RFID reader 14C then mixes the recovered data with a transmit oscillation to produce an up-converted signal. The RFID reader 14C then transmits the up-converted signal to produce the repeat RFID response signal.

RFID reader 14C may identify RFID reader 14B in a variety of ways. For example, RFID reader 14C may identify, or determine, RFID reader 14B based on an established relationship with RFID reader 14B concerning the RFID tag 16B. For example, RFID reader 14C may be programmed to provide any responses from RFID tag 16B to RFID reader 14B. This may be pre-programmed or programmed based on RFID tags affiliated with RFID reader 14C. As another example, RFID 14C may generally broadcast the repeat RFID request signal, which is received by RFID reader 14B. In yet another example, the RFID response may contain the identity of RFID reader 14B. For instance, if the request message from RFID reader 14C to RFID tag 16B was a repeat of a request message from the network RFID 12 that includes a list of RFID readers the message has traversed, then RFID reader 14C uses the list to identify RFID reader 14B.

Upon receiving the repeat RFID response message, the RFID reader 14B repeats it and forwards the repeat RFID response signal to RFID reader 14A in a similar fashion as RFID reader 14C forwarded the repeat RFID response message to it. RFID reader 14A performs a similar process and forwards the repeat message to the network RFID reader 12.

As an alternative, the request 30 may be originated by the network RFID reader 12. In this instance, the network RFID reader 12 may generate the RFID request message 30 or it may be forwarding the request from the computer and/or server coupled to the network connection 18. In either case, the network RFID reader 12 transmits the RFID request message, or signal, 30 to RFID reader 14A.

RFID reader 14A processes the RFID request message to recover data contained therein. The RFID reader 14A then interprets the recovered data to identify the RFID tag. In one embodiment, the RFID reader 14A interprets the recovered data to determine an RFID reader forwarding chain (e.g., for the example request 30, the chain includes RFID reader 14A, 14B, and 14C). In this embodiment, since RFID reader 14A is not at the RFID tag end of the chain, the RFID reader 14A determines that the RFID request message 30 is to be repeated. In another embodiment, the recovered data may include a command for each reader in the chain telling the reader what to do with the RFID request message (e.g., forward to another RFID reader, send to the RFID tag, ignore, etc.). In yet another embodiment, the RFID reader 14A interprets the recovered data to determine whether the targeted RFID tag is affiliated with the RFID reader 14A. If the targeted RFID tag is not affiliated with the RFID reader 14A, then the RFID reader 14A determines that the RFID request message is to be repeated. If the targeted RFID tag is affiliated with the RFID reader 14A, then the RFID reader 14A provides the RFID request message to the RFID tag.

When the RFID request message is to be forwarded, the RFID reader 14A mixes the recovered data with a transmit oscillation to produce an up-converted signal. The RFID reader 14A then transmits the up-converted signal to provide the repeating of the RFID request message.

RFID reader 14B performs a similar forwarding function of the RFID request message 30 as the forwarding performed by RFID reader 14A. RFID reader 14C, however, determines that the targeted RFID tag 16B is within its coverage area. Thus, instead of forwarding the RFID message to another reader, it sends the RFID request message to the targeted RFID tag 16B and waits for a response 32. The RFID response message, or signal, 32 is forwarded back to the network RFID reader 12 as previously discussed. Note that the up-stream path (i.e., the path which the request 30 traversed) may use a first carrier frequency and the down-stream path (i.e., the path which the response 32 traversed) may use a second carrier frequency. Further note that the up-stream and down-stream paths may use the same carrier frequency. Still further note that an RFID reader may receive an RFID signal (e.g., a request or response) via a first frequency carrier and repeat it at a second carrier frequency.

With respect to a third communication, the targeted RFID tag 16C is affiliated with RFID reader 14D, which is in an adjacent cell to that of the network RFID reader 12. In this example, RFID reader 14D forwards a request from the network RFID reader 12 to the targeted RFID tag 16C and forwards the response from the targeted RFID tag 16C to the network RFID 12. As an alternative, RFID reader 14D may generate the request message and provide it to the targeted RFID tag. The RFID reader 14D still, however, forwards the RFID tag's response to the network RFID reader 12.

With respect to a fourth communication, the targeted RFID tag 16D is affiliated with RFID reader 14E. In this example, RFID reader 14D provides the peer-to-peer communication between the network RFID reader 12 and RFID reader 14E in a similar manner as RFID reader 14A provided peer-to-peer support for the first example communication. Further in this example, RFID reader 14E performs a similar function to that of RFID reader 14C for the first example communication.

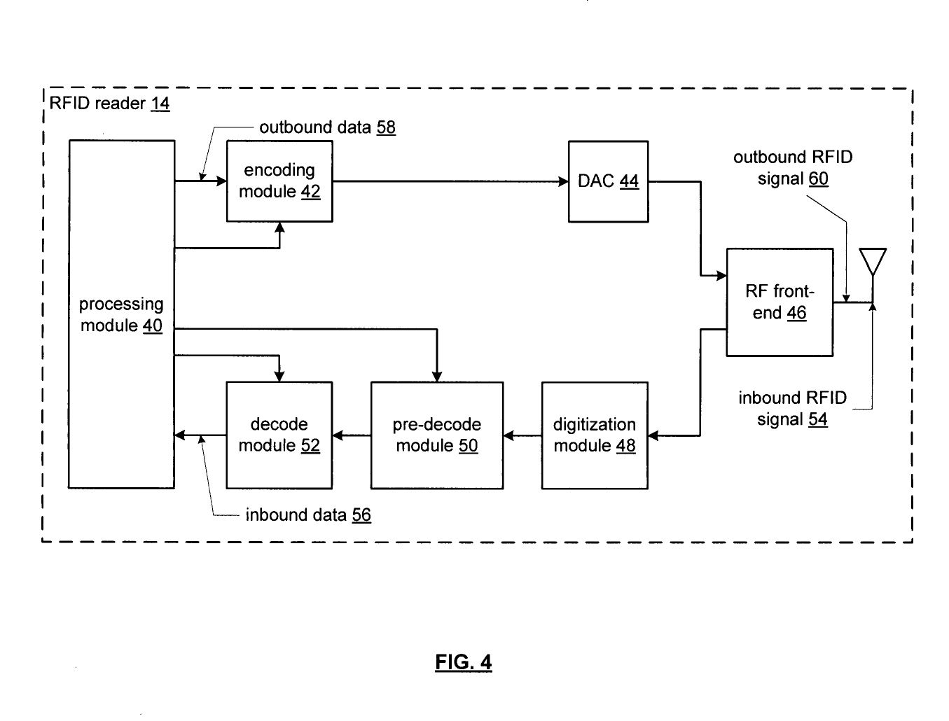

FIG. 4 is a schematic block diagram of an RFID reader 14 that includes a transmit section, a receive section, and a processing module 40. The transmit section includes an encoding module 42, a digital to analog conversion module 44, and a transmitting portion of an RF front-end 46. The receive section includes a receiving portion of the RF front-end 46, a digitization module 48, a pre-decoding module 50, and a decoding module 52. The receiving portion of the RF front-end 46 may include a blocking circuit, a low noise amplifier, and a down-conversion module. The transmitting portion of the RF front end 46 may include an up-conversion module and a power amplifier.

In operation, the RF front end 46, which is coupled to an antenna structure of one or more antennas, receives an inbound RFID signal 54. The inbound RFID signal 54 may be an RFID request message or an RFID response message. If the inbound RFID signal is a request message, it may be received from the network RFID reader 12 or another one of the RFID readers 14. If the inbound RFID signal is a response message, it may be received from an RFID tag or another one of the RFID readers 14.

The blocking circuit of the RF front-end 46 blocks an outbound RFID signal 60 and passes the inbound RFID signal 54 to the low noise amplifier when the inbound and outbound signals 54 and 60 have substantially the same carrier frequency. The low noise amplifier amplifies the inbound RFID signal 54 and provides the amplified inbound RFID signal to the down conversion module. The down conversion module mixes the amplified inbound RFID signal with a local oscillation to produce a baseband (i.e., a carrier frequency of 0 Hz) or near baseband (i.e., a carrier frequency of a few MHz or less) signal. Note that in one embodiment, the amplified inbound RFID signal and local oscillation each includes an in-phase component and a quadrature component such that the resulting baseband or near baseband includes an in-phase component and a quadrature component.

In an alternate embodiment of the receiving portion of the RF front-end 46, a blocking circuit includes a low noise amplifier coupled in series with a notch filter. The notch filter has a filtering characteristic to attenuate a desired signal component and pass, substantially unattenuated, an undesired signal component. The RF front-end 40 further includes a second low noise amplifier that amplifies the desired and undesired signal components of the inbound RF signal to produce an amplified inbound RF signal. The substantially unattenuated undesired signal component is subtracted from the amplified inbound RF signal yielding the desired signal component, which is converted to the baseband or near baseband signal. This embodiment may be used when the inbound RF signal is at one carrier frequency and the outbound RF signal is at a second carrier frequency.

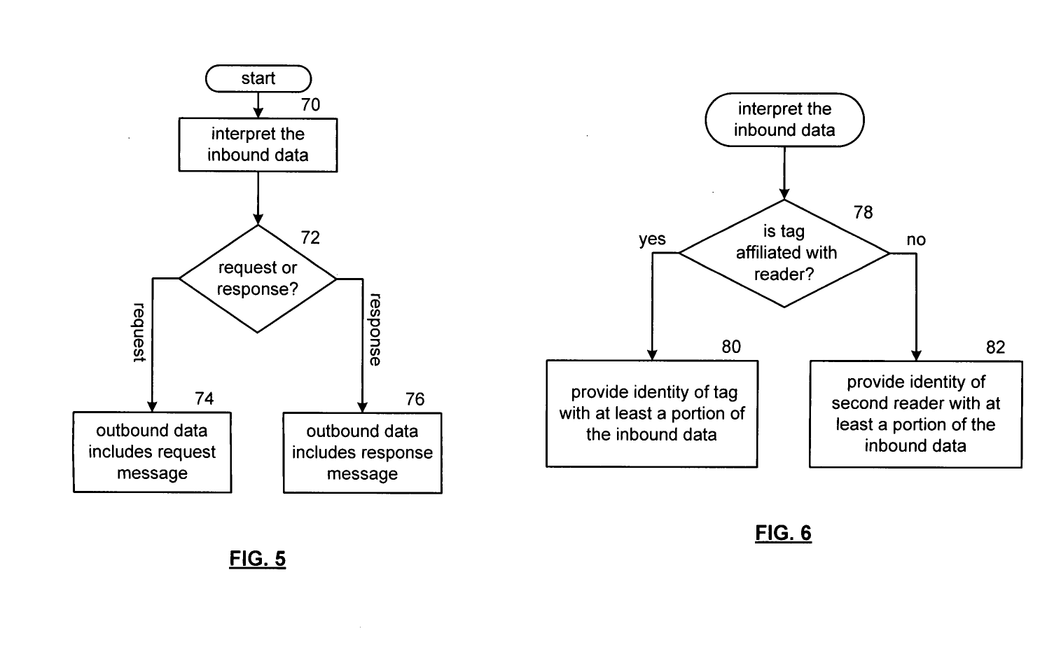

The digitization module 48, -which may be a limiting circuit and/or an analog to digital converter, converts the baseband or near baseband signal into a digital encoded signal. The pre-decoding module 50 and the decoding module 52 convert the digital encoded signal into inbound data 56. The processing module 40 processes the inbound data to determine whether the inbound RFID signal 54 is to be repeated and may also determine the target of the repeated message. Note that the processing module 40 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have, or include, an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 5 and 6.

When the inbound RFID signal 54 is to be repeated, the processing module 40 provides the inbound data 56 to the encoding module 42 as outbound data 58. The processing module 40 may also include reader chain information, targeted RFID tag information, additional command messages, etc. in the outbound data 58. The encoding module 42 encodes the outbound data using one of FM0, FM1, EPC class 0, EPC class 1, or other RFID encoding protocol, to produce encoded outbound data. The digital to analog converter 44 converts the encoded outbound data into an analog signal. The up-conversion module of the RF front-end 46 mixes the analog signal with a local oscillation to produce an up-converted, or mixed, signal. The power amplifier of the RF front-end 46 amplifies the up-converted signal to produce the outbound RF signal 60.

In an example, the RFID reader may repeat a RFID request message from the network RFID reader to a tag. The reader then recovers data contained within the RFID request message to produce recovered data. The reader then interprets the recovered data to identify the RFID tag. The reader then mixes the recovered data with a transmit oscillation to produce an up-converted signal. The reader then transmits the up-converted signal to the tag as a repeat RFID request message. Note that the recovered data may include one or more of synchronization information, a source ID, a destination ID, packet length, down-stream chain IDs, up-stream chain IDs, message, command, etc.

In another example, the RFID reader may repeat a RFID response signal from a tag to the network RFID reader by receiving the RFID response message from the RFID tag. The RFID reader then recovers data contained within the RFID response message to produce recovered data. The RFID reader then mixes the recovered data with a transmit oscillation to produce an up-converted signal. The RFID reader then transmits the up-converted signal to provide the RFID response signal to the network RFID reader.

In another example, the RFID reader may repeat an RFID request message to a RFID tag or to another RFID reader by recovering data from the RFID request message to produce recovered data. The reader then interprets the recovered data to identify the RFID tag. The reader then determines whether the RFID tag is currently affiliated with the RFID reader. The reader then up-converts the recovered data to produce a repeat RFID request signal. The reader then provides the repeat RFID request signal as the RFID signal to the RFID tag when the RFID tag is affiliated with the RFID reader or provides the repeat RFID request signal as the RFID signal to the second RFID reader when the RFID tag is not affiliated with the RFID reader. The reader may determine the second RFID reader based on an established relationship with the second RFID reader concerning the RFID tag, interpreting the recovered data to identify the second RFID reader, and/or generally broadcasting the repeat RFID request signal to RFID readers of the plurality of readers within a coverage area of the RFID reader, wherein the second RFID reader is one of the RFID readers of the plurality of RFID readers.

In another example, the RFID reader may repeat an RFID response signal to the network RFID reader to a third RFID reader by receiving the RFID response signal from at least one of the RFID tag and the second RFID reader. The RFID reader then recovers data from the RFID response signal to produce recovered data. The reader then interprets the recovered data to identify the at least one of the network RFID reader and the third RFID reader. The reader then up-converts the recovered data to produce a repeat RFID response signal. The reader transmits the repeat RFID response signal to the network RFID reader and/or the third RFID reader. Note that the reader may determine the network RFID reader or the third RFID reader based on an established relationship with the network RFID reader concerning the RFID tag, interpreting the RFID response signal to identify the network RFID reader, based on an established relationship with the third RFID reader concerning the RFID tag, interpreting the RFID response signal to identify the third RFID reader, and generally broadcasting a repeat RFID response signal to RFID readers of the plurality of readers within a coverage area of the RFID reader, wherein the network RFID reader and/or the third RFID reader is one of the RFID readers of the plurality of RFID readers.

FIG. 5 is a logic diagram of a method for peer-to-peer communication in an RFID system that begins at step 70 where the RFID reader interprets inbound data. The process then proceeds to step 72 where the reader determines whether the inbound data corresponds to an RFID response message or an RFID request message. When inbound data correspond to the RFID response message, the process proceeds to step 76 where the reader includes the response message in the outbound data for subsequent repeating of the RFID response message. When inbound data correspond to the RFID request message, the process proceeds to step 74 where the reader includes the request message in the outbound data for subsequent repeating of the RFID request message.

FIG. 6 is a logic diagram of method for interpreting the inbound data of step 70 of FIG. 5. The process begins at step 78 where the reader determines whether the tag is affiliated with the reader. When the tag is affiliated with the reader, the process proceeds to step 80 where the reader provides identity of the tag with the outbound data. When the tag is not affiliated with the reader, the process proceeds to step 82 where the reader provides identity of the second RFID reader with the outbound data.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal I has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A radio frequency identification (RFID) system comprises:
a network RFID reader coupled to a network connection;
an RFID tag coupled to generate an RFID response signal in response to an RFID signal; and
an RFID reader coupled to:
provide the RFID signal to the RFID tag; and
provide the RFID response signal to the network RFID reader.

2. The RFID system of claim 1, wherein the RFID reader is coupled to provide the RFID signal to the RFID tag further comprises:
receiving an RFID request message from the network RFID reader; and
repeating the RFID request message to the RFID tag as the RFID signal.

3. The RFID system of claim 2, wherein the RFID reader is coupled to provide the RFID signal to the RFID tag further comprises:
receiving the RFID request message from the network RFID reader, wherein the RFID request message has a first carrier frequency; and
repeating the RFID request message to the RFID tag as the RFID signal, wherein the RFID signal has a second carrier frequency.

4. The RFID system of claim 2, wherein the RFID reader is coupled to provide the RFID signal to the RFID tag further comprises:
receiving the RFID request message from the network RFID reader;
recovering data contained within the RFID request message to produce recovered data;
interpreting the recovered data to identify the RFID tag;
mixing the recovered data with a transmit oscillation to produce an up-converted signal; and
transmitting the up-converted signal to provide the repeating of the RFID request message.

5. The RFID system of claim 1, wherein the RFID reader is coupled to provide the RFID signal to the RFID tag further comprises:
generating an RFID request message; and
transmitting the RFID request message as the RFID signal to the RFID tag.

6. The RFID system of claim 1, wherein the RFID reader is coupled to provide the RFID response signal to the network RFID reader further comprises:
receiving the RFID response message from the RFID tag;
recovering data contained within the RFID response message to produce recovered data;
mixing the recovered data with a transmit oscillation to produce an up-converted signal; and
transmitting the up-converted signal to provide the RFID response signal to the network RFID reader.

7. A radio frequency identification (RFID) system comprises:
a network RFID reader coupled to a network connection;
a plurality of RFID tags, wherein an RFID tag of the plurality of RFID tags is coupled to generate an RFID response signal in response to an RFID signal; and
a plurality of RFID readers, wherein an RFID reader of the plurality of RFID readers is coupled to:
provide the RFID signal to at least one of the RFID tag and a second RFID reader of the plurality of RFID readers; and
provide the RFID response signal to at least one of the network RFID reader and a third RFID reader of the plurality of RFID readers.

8. The RFID system of claim 7, wherein the RFID reader is coupled to provide the RFID signal to at least one of the RFID tag and the second RFID reader further comprises:
receiving an RFID request message from at least one of the network RFID reader and the third RFID reader; and
repeating the RFID request message to the RFID tag or to the second RFID reader as the RFID signal.

9. The RFID system of claim 8, wherein the RFID reader is coupled to repeat the RFID request message to the RFID tag or to the second RFID reader further comprises:
recovering data from the RFID request message to produce recovered data:
interpreting the recovered data to identify the RFID tag;
determining whether the RFID tag is currently affiliated with the RFID reader;
up-converting the recovered data to produce a repeat RFID request signal; and
when the RFID tag is affiliated with the RFID reader, providing the repeat RFID request signal as the RFID signal to the RFID tag.

10. The RFID system of claim 9, wherein the RFID reader is coupled to repeat the RFID request message to the RFID tag or to the second RFID reader further comprises:
providing the repeat RFID request signal as the RFID signal to the second RFID reader when the RFID tag is not affiliated with the RFID reader.

11. The RFID system of claim 10, wherein the RFID reader is coupled to provide the repeat RFID request signal as the RFID signal to the second RFID reader further comprises at least one of:
determining the second RFID reader based on an established relationship with the second RFID reader concerning the RFID tag;
interpreting the recovered data to identify the second RFID reader; and
generally broadcasting the repeat RFID request signal to RFID readers of the plurality of readers within a coverage area of the RFID reader, wherein the second RFID reader is one of the RFID readers of the plurality of RFID readers.

12. The RFID system of claim 7, wherein the RFID reader is coupled to provide the RFID signal to the RFID tag further comprises:
generating an RFID request message; and
transmitting the RFID request message as the RFID signal to the RFID tag.

13. The RFID system of claim 12, wherein the RFID reader is coupled to generate the RFID request message further comprises at least one of:
responding to a polling message from the network RFID reader;
responding to a token scheme; and
responding to a predetermined requesting of information from the RFID tag.

14. The RFID system of claim 7, wherein the RFID reader is coupled to:
provide the RFID signal to at least one of the RFID tag and the second RFID reader using an up-stream carrier frequency; and
provide the RFID response signal to at least one of the network RFID reader and the third RFID reader using a down-stream carrier frequency.

15. The RFID system of claim 7, wherein the RFID reader is coupled to:
provide the RFID signal to the RFID tag using a first carrier frequency;
provide the RFID signal to the second RFID reader using a second carrier frequency; and
provide the RFID response signal to at least one of the network RFID reader and the third RFID reader using the second carrier frequency.

16. The RFID system of claim 7, wherein the RFID reader is coupled to provide the RFID response signal to at least one of the network RFID reader and the third RFID reader further comprises:
receiving the RFID response signal from at least one of the RFID tag and the second RFID reader; and
repeating the RFID response signal to at least one of the network RFID reader and the third RFID reader.

17. The RFID system of claim 16, wherein the RFID reader is coupled to provide the RFID response signal to at least one of the network RFID reader and the third RFID reader further comprises:
recovering data from the RFID response signal to produce recovered data;
interpreting the recovered data to identify the at least one of the network RFID reader and the third RFID reader;
up-converting the recovered data to produce a repeat RFID response signal; and
transmitting the repeat RFID response signal.

18. The RFID system of claim 7, wherein the RFID reader is coupled to provide the RFID response signal to at least one of the network RFID reader and the third RFID reader further comprises:
determining the network RFID reader based on an established relationship with the network RFID reader concerning the RFID tag;
interpreting the RFID response signal to identify the network RFID reader;
determining the third RFID reader based on an established relationship with the third RFID reader concerning the RFID tag;
interpreting the RFID response signal to identify the third RFID reader; and
generally broadcasting a repeat RFID response signal to RFID readers of the plurality of readers within a coverage area of the RFID reader, wherein the at least one of the network RFID reader and the third RFID reader is one of the RFID readers of the plurality of RFID readers.

19. A radio frequency identification (RFID) reader comprises:
a receive section coupled to convert an inbound RFID signal into inbound data;
a transmit section coupled to convert outbound data into an outbound RFID signal; and
a processing module coupled to:
interpret the inbound data;
when the inbound data corresponds to an RFID request message from a network RFID reader or a third RFID reader, provide at least a portion of the inbound data corresponding to the RFID request message as the outbound data to the transmit section; and
when the inbound data corresponds to an RFID response message from an RFID tag or a second RFID reader, provide the at least a portion of the inbound data corresponding to the RFID response message as the outbound data to the transmit section.

20. The RFID reader of claim 19, wherein the processing module coupled to interpret the inbound data as corresponding to the RFID request message further comprises:
determining whether the RFID tag is currently affiliated with the RFID reader;
when the RFID tag is affiliated with the RFID reader, providing identity of the RFID tag along with the providing of the at least a portion of the inbound data to the transmit section; and
when the RFID tag is not affiliated with the RFID reader, providing identity of the second RFID reader along with the providing of the at least a portion of the inbound data to the transmit section.

21. The RFID reader of claim 20, wherein the processing module is coupled to provide the identity of the second RFID reader further comprises at least one of:
determining the second RFID reader based on an established relationship with the second RFID reader concerning the RFID tag; and
interpreting the inbound data to identify the second RFID reader.

22. The RFID reader of claim 19, wherein the processing module is coupled to:
generating an RFID request message as the outbound data.

23. The RFID reader of claim 22, wherein the processing module is coupled to generate the RFID request message further comprises at least one of:
responding to a polling message from the network RFID reader;
responding to a token scheme; and
responding to a predetermined requesting of information from the RFID tag.

24. The RFID reader of claim 19, wherein the transmit section is coupled to:
convert outbound data into an outbound RFID signal using an up-stream carrier frequency when the outbound RFID signal is targeting the RFID tag or the second RFID reader; and
convert outbound data into an outbound RFID signal using a down-stream carrier frequency when the outbound RFID signal is targeting the network RFID reader or the third RFID reader.

25. The RFID reader of claim 19, wherein the transmit section is coupled to:
convert outbound data into an outbound RFID signal using an up-stream carrier frequency when the outbound RFID signal is targeting the RFID tag; and
convert outbound data into an outbound RFID signal using a down-stream carrier frequency when the outbound RFID signal is targeting the network RFID reader, the second RFID reader, or the third RFID reader.

26. The RFID reader of claim 19, wherein the processing module is further coupled to:
provide identity of at least one of the network RFID reader, the second RFID reader, the third RFID reader and the RFID tag.

27. The RFID reader of claim 26, wherein the processing module is coupled to provide the identity of at least one of the network RFID reader, the second RFID reader, the third RFID reader and the RFID tag further comprises:
determining at least one of the network RFID reader, the second RFID reader, and the third RFID reader based on an established relationship with the network RFID reader concerning the RFID tag;
interpreting the inbound data to identify the at least one of the network RFID reader, the second RFID reader, and the third RFID reader; and
generally broadcasting a repeat RFID signal of the inbound RFID signal to a plurality of readers within a coverage area of the RFID reader, wherein the at least one of the network RFID reader, the second RFID reader, and the third RFID reader is one of the plurality of RFID readers.
